(19) United States
(12) Patent Application Publication
(10) Pub. No.: US 2004/0083484 A1
(43) Pub. Date: Apr. 29, 2004

(54) Commercial replacement on personal digital recordings

(75) Inventor: Kim Annon Ryal, Poway, CA (US)

Correspondence Address: ROGITZ & ASSOCIATES, Suite 3120, 750 B Street, San Diego, CA, 92101, US

(73) Assignees: SONY CORPORATION, Tokyo (JP); SONY ELECTRONICS INC., Park Ridge, NJ (US)

(21) Appl. No.: 10/282,270

(22) Filed: Oct. 28, 2002

(51) Int. Cl. H04N 7/16; H04N 7/025; H04N 7/10

(52) U.S. Cl. 725/1; 725/2; 725/32

(57) ABSTRACT

A recording of a televised content stream that has been recorded by a digital recorder is periodically refreshed with updated commercials by pushing the updates down to the viewer's device or pulling the updates from the source, so that when the viewer plays back the recording, he may view, if desired, commercials that are more timely than those that were originally recorded.

### FIELD OF THE INVENTION

The present invention relates generally to television systems.

### BACKGROUND

Modern digital television systems can be programmed to record broadcast content, including broadcast digitized content, that is received over a satellite link or cable link. The content typically includes television programs and accompanying commercials, and once programmed, the recording device of a system usually records both the desired programs and the commercials.

Because many viewers do not wish to view commercials, provisions have been made to allow them to skip over commercials while playing back recorded content. Naturally, the advertisers who paid for the commercials would like the viewers to see the commercials during play back, but the propensity of viewers to skip over commercials remains, and moreover becomes ever greater as programs age. This is because the commercials in recorded content become dated and thus of even less interest to viewers than during live broadcasts, representing, as they do, products that might no longer be made, sales events that have long since passed since the original broadcast, or even companies that might no longer be in business. Having made the above critical observations, the invention below is provided.

### SUMMARY OF THE INVENTION

A system for updating recorded televised content includes a viewer recording device, a display (such as a TV) coupled to the recording device, and a source of content (such as a cable “head end”) that communicates content to the recording device. After content is recorded, an original commercial in the content that was recorded by the recording device is replaced with a replacement commercial.

In one preferred non-limiting embodiment, an advertiser who is associated with the replacement commercial is billed, either for transmitting the replacement commercial to the recording device or only upon play back of the replacement commercial during play back of the content. The replacement commercial may be requested (“pulled”) by the viewer's system when a predetermined period has elapsed after recording the content or when a play back command has been received from a viewer. Or, the replacement commercial can be “pushed” to the viewer recording device upon the initiative of the source, without a request therefor from the viewer recording device.

In another aspect, a method for providing recorded broadcast content to a viewer includes broadcasting the content, including at least one originally-recorded commercial, and then recording the content at a viewer recording device that is associated with a viewer television. The method also includes replacing the originally-recorded commercial with a replacement commercial, such that upon receipt of a play back command, the recording device is caused to play back the content with replacement commercial for display thereof on the television.

In still another aspect, a viewer entertainment system includes a television and an associated digital recording device. A processor is associated with the recording device. The recording device records content including at least one original commercial from a broadcast content source. In accordance with the present invention, the processor replaces the original commercial with a replacement commercial.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a system of the present invention;

FIG. 2 is a flow chart of the record logic; and

FIG. 3 is a flow chart of the logic for updating/playing back recorded content.

### DETAILED DESCRIPTION OF THE PREFERRED EMBODIMENT

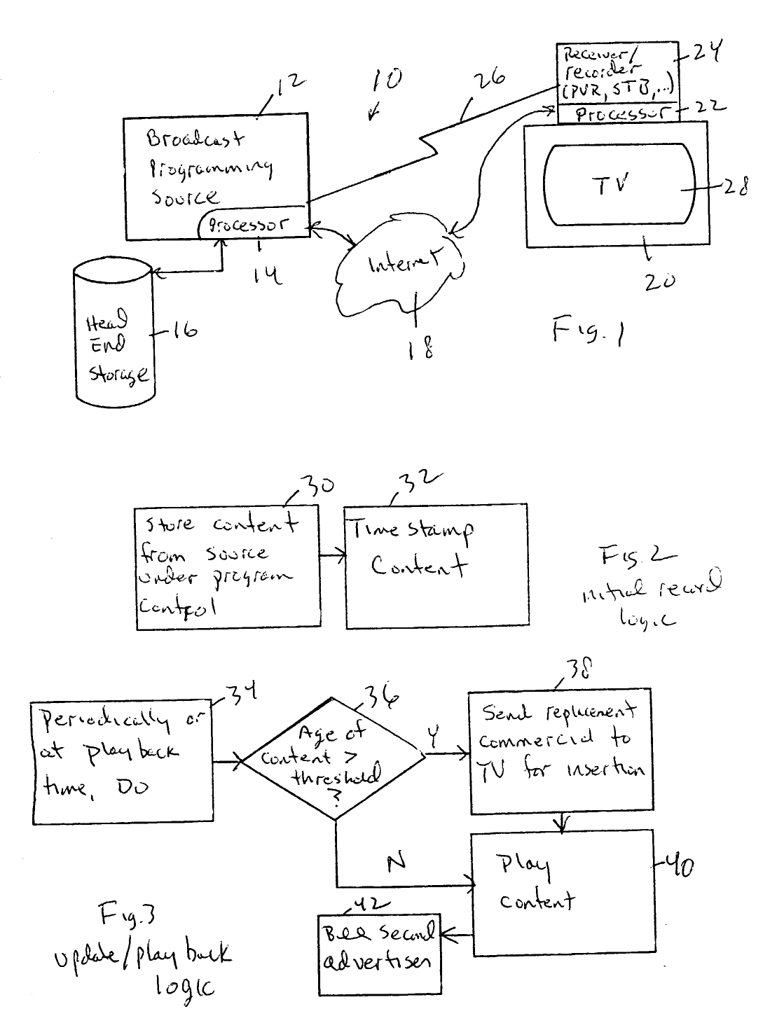

Referring initially to FIG. 1, cable or satellite television (TV) system 10 is shown that includes a broadcast programming/content source 12, sometimes referred to as a “head end” of a service provider. The source 12 includes a processor 14, which could be embodied in a media server for providing in a broadcast or on demand movies, television shows, and other programming content that may be obtained from a head end data storage 16. The source processor 14 may also provide additional content that is available on the Internet 18. It is to be understood that the source 12 includes an appropriate transmitter for broadcasting content in accordance with cable, satellite, or other broadcast principles known in the art.

The system 10 also includes plural viewer television systems, only one of which is shown in FIG. 1 for convenience of disclosure. Accordingly, a viewer's television 20 is provided that may be coupled to one or more local processors 22 for undertaking the present invention. The local processor 22 may be embodied in a personal digital recorder that can be implemented as personal video recorder (PVR), separate from or integrated into a set top box 24, or other recording device. If desired, all of the viewer components shown in FIG. 1 may be housed together, or they may be separate components as shown.

The preferred set top box 24 can provide bi-directional communication over a transmission path 26 with the source 12, in the case of a cable-based system 10. In other embodiments, bidirectional communication can be effected using asymmetrical communication techniques such as dual communication media—one for the uplink and one for the downlink. Specifically, content can be received from the source 12 over the path 26, which might be a satellite link, while communication from the local processor 22 to the source 12 can be provided via the Internet 18.

Accordingly, the source processor 14 can be coupled by the transmission path 26 to the STB 24. The transmission path 26 may include, for example, a conventional coaxial cable network, a fiber optic cable network, telephone system, or a twisted pair. Or, as mentioned above the transmission path 26 may be wireless, in which case it can include a satellite communication system, a radio frequency (RF) system, a microwave system, other wireless systems, a combination of wired and wireless systems or any of a variety of known electronic transmission mediums. In the case of a cable television network, the transmission path 26 is commonly realized at the subscriber's premises as a coaxial cable that is connected to a suitable cable connector at the rear panel of the STB 24. In the case of a Direct Satellite System (DSS), the STB 24 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 24.

The TV 20 may be a digital television having a video display 28 for displaying programming, an electronic program guide (EPG), etc. The STB 24 may be coupled to the TV 24 and various other audio/visual devices 26. In addition to the local processor 22, the preferred non-limiting STB 24 may include memory such as Random Access Memory (RAM), Read Only Memory (ROM), flash memory, mass storage such as a hard disc drive, floppy disc drive, optical disc drive or may accommodate other electronic storage media, etc. Such memory and storage media are suitable for storing data as well as instructions for programmed processes for execution on the local processor 22, in accordance with principles set forth below. Also, the STB 24 may include circuitry suitable for audio decoding and processing, as well as the decoding of video data compressed in accordance with a compression standard such as the Motion Pictures Experts Group (MPEG) standard and other processing to form a controller or central hub.

In a non-limiting embodiment, the STB 24 may be coupled to devices such as a personal computer, video cassette recorder, camcorder, digital camera, personal digital assistant and other audio/visual or Internet related devices. Moreover, the STB 24 may be coupled to other STBs of other viewers through, e.g., a local area network or the Internet, so that the STBs can share data, including recorded content, with each other.

In addition, a data transport architecture, such as that set forth by an industry group which includes Sony Corporation and known as the Home Audio-Video Interoperability (HAVi) architecture may be used to enable interoperability among devices on a network regardless of the manufacturer of the device. This forms a home network system wherein electronic devices and Internet appliances are compatible with each other. The preferred non-limiting system 10 can run an operating system that is suitable for a home network system such as Sony Corporation's Aperios™ real time operating system.

As mentioned above and as shown in FIG. 1, the local processor 22 may be coupled to an independent service provider (ISP) host by a suitable Internet-based connection including dial-up connections, DSL (Digital Subscriber Line) or even the same transmission path 26 described above (e.g. using a cable modem) to, thus, provide access to services and content from the Internet 18.

Now referring to FIG. 2, commencing at block 30 content which is broadcast from the source 12 over the air or cable or other medium using an appropriate broadcast transmitter at the source 12 is received and recorded by the STB 24/recorder, preferably under control of the processor 22. At block 32, the content is timestamped. By “timestamped” is meant that either the time of recording the content is noted and stored by the processor 22, or time-indicating indicia received in the content is noted and stored. In any case, the time data preferably is available to the local processor 22. In the case wherein replacement commercials are “pushed” to the recording device 24 as discussed further below, the time data need be available only to the source processor 14.

FIG. 3 shows the logic post-recording. Block 34 indicates that the subsequent logic is undertaken either periodically (at least once), or at the time that a play back command has been input to the STB 24/recorder by the viewer. When done periodically, the following logic can be initiated by the source processor 14 without intervention from the viewer's system, i.e., the source 12 can periodically “push” replacement commercials to the STB 24/recorder without receiving a request therefor from the STB 24/recorder.

Alternatively, when done periodically, the following logic can be initiated by the local processor 22 (i.e., the local processor “pulls” the replacement commercial from the source 12).

Proceeding to decision diamond 36, it is determined whether the age of the content (and, hence, any commercials in the content stream that were originally recorded with the content) exceeds a predetermined threshold, e.g., three months. That is, it is determined how long ago the content was recorded, using, e.g., the timestamp data discussed above. If the threshold is exceeded, the logic moves to block 38 to cause a replacement commercial to be sent, via broadcast or Internet connection, to the processor 22. Preferably, all originally-recorded commercials are replaced, although only one original commercial might be replaced by a replacement commercial if desired.

By “replaced” is meant that the replacement commercial is present in the content stream during play back and the originally-recorded commercial is not. Preferably, the replacement commercial occupies the same place in the content stream as did the original commercial. A replacement commercial might be established by only partially updating an originally-recorded commercial. In any case, at block 40 the recorded content is played back to the viewer, who may then elect to skip (or not) any replacement commercials in the content.

Block 42 indicates that the advertiser who is associated with the replacement commercial is billed. The advertiser may be billed simply for transmitting the replacement commercial to the STB 24/recorder, whether by “push” or by “pull”. Or, the advertiser may be billed only upon playing back the replacement commercial during play back of the content. In the second case, the local processor 22 sends a message to the source processor via a cable or Internet communication path indicating that the content has been played and, if desired, whether the viewer skipped all or part of the replacement commercial during play back. The billing may be done by the source processor 14 or by another billing entity associated with the source 12.

While the particular COMMERCIAL REPLACEMENT ON PERSONAL DIGITAL RECORDINGS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”.

What is claimed is:

1. A system for updating recorded televised content, comprising:
at least one viewer recording device;
at least one display coupled to the recording device; and
at least one source of content communicating content to the recording device;
wherein after content is recorded, at least one original commercial in the content recorded by the recording device is replaced with at least one replacement commercial.

2. The system of claim 1, comprising billing an advertiser associated with the replacement commercial.

3. The system of claim 2, wherein the advertiser is billed for transmitting the replacement commercial to the recording device.

4. The system of claim 2, wherein the advertiser is billed only upon playing back the replacement commercial during play back of the content.

5. The system of claim 1, wherein the replacement commercial is requested from the source when a predetermined period has elapsed after recording the content.

6. The system of claim 1, wherein the replacement commercial is requested from the source upon receipt of a play back command from a viewer.

7. The system of claim 1, wherein the replacement commercial is pushed to the viewer recording device upon the initiative of the source, without a request therefor from the viewer recording device.

8. The system of claim 1, wherein the recording device is a digital recording device.

9. A method for providing recorded broadcast content to a viewer, comprising:
broadcasting the content from a source,
the content including at least one originally-recorded commercial;
recording the content at a viewer recording device,
the viewer recording device being associated with a viewer television;
replacing the originally-recorded commercial with at least one replacement commercial; such that
upon receipt of a play back command, the recording device is caused to play back the content with replacement commercial for display thereof on the television.

10. The method of claim 9, wherein the replacement commercial occupies the same place in content as formerly occupied by the originally-recorded commercial.

11. The method of claim 9, wherein the recording device is a digital recording device.

12. The method of claim 9, comprising billing an advertiser associated with the replacement commercial.

13. The method of claim 12, wherein the advertiser is billed for transmitting the replacement commercial to the recording device.

14. The method of claim 12, wherein the advertiser is billed only upon playing back of the replacement commercial during play back of the content.

15. The method of claim 9, comprising requesting the replacement commercial from the source when a predetermined period has elapsed after recording the content.

16. The method of claim 9, comprising requesting the replacement commercial from the source upon receipt of a play back command from a viewer.

17. The method of claim 9, comprising automatically transmitting the replacement commercial to the viewer recording device upon the initiative of the source, without a request therefor from the recording device.

18. A viewer entertainment system, comprising:
at least one television;
at least one digital recording device; and
at least one processor associated with the recording device, the recording device recording content including at least one original commercial from a broadcast content source, the processor replacing the original commercial with a replacement commercial.

19. The system of claim 18, wherein the recording device is incorporated in a set top box.

20. The system of claim 18, wherein the replacement commercial occupies the same place in content as formerly occupied by the originally-recorded commercial.

21. The system of claim 18, wherein the processor requests the replacement commercial from the source when a predetermined period has elapsed after recording the content.

22. The system of claim 18, wherein the processor requests the replacement commercial from the source upon receipt of a play back command from a viewer.

23. The system of claim 18, wherein the replacement commercial is automatically received by the processor without initiating a request therefor from the processor.

24. A system for providing recorded broadcast content to a viewer, comprising:
means for broadcasting the content,
the content including at least one originally-recorded commercial;
means for recording the content at a viewer entertainment system including a television; and
means for replacing the originally-recorded commercial with at least one replacement commercial, such that
upon receipt of a play back command, the entertainment system is caused to play back the content with replacement commercial for display thereof on the television.

25. The system of claim 24, wherein the replacement commercial occupies the same place in content as formerly occupied by the originally-recorded commercial.

26. The system of claim 24, comprising means for billing an advertiser associated with the replacement commercial.
